(19) United States
(12) Patent Application Publication
(10) Pub. No.: US 2023/0185749 A1
(43) Pub. Date: Jun. 15, 2023

(54) SYSTEMS AND METHODS FOR PARALLEL PROCESSING

(71) Applicant: Alibaba (China) Co., Ltd., Hangzhou (CN)

(72) Inventors: Liang HAN, Campbell, CA (US); ChengYuan WU, Fremont, CA (US); Guoyu ZHU, San Jose, CA (US); Rong ZHONG, Fremont, CA (US); Yang JIAO, San Jose, CA (US); Ye LU, Shanghai (CN); Wei WU, Shanghai (CN); Yunxiao ZOU, Shanghai (CN); Li YIN, Shanghai (CN)

(21) Appl. No.: 17/824,814

(22) Filed: May 25, 2022

(30) Foreign Application Priority Data
Dec. 15, 2021 (CN) 202111561477.3

(51) Int. Cl. G06F 13/40

(52) U.S. Cl. CPC G06F 13/4022; G06F 13/4063; G06F 2213/0026

(57) ABSTRACT

A system includes a high-bandwidth inter-chip network (ICN) that allows communication between neural network processing units (NPUs) in the system. For example, the ICN allows an NPU to communicate with other NPUs on the same compute node (server) and also with NPUs on other compute nodes (servers). Communication can be at the direct memory access (DMA) command level and at the finer-grained load/store instruction level. The ICN system and the programming model allows NPUs in the system to communicate without using a traditional network (e.g., Ethernet) that uses a relatively narrow and slow Peripheral Component Interconnect Express (PCIe) bus.

### CROSS-REFERENCE TO RELATED APPLICATION

This patent application claims priority to China Patent Application No. 202111561477.3 filed Dec. 15, 2021 by Liang HAN et al., which is hereby incorporated by reference in its entirety.

### BACKGROUND

FIG. 1 is a block diagram illustrating an example of a conventional system 100 that can be used for accelerating neural networks. In general, the system 100 includes a number of servers, and each server includes a number of parallel computing units. In the example of FIG. 1, the system 100 includes servers 101 and 102. The server 101 includes neural network processing units (NPUs) NPU_0, . . . , NPU_n that are connected to a Peripheral Component Interconnect Express (PCIe) bus 111, and the server 102 includes a like array of NPUs connected to the PCIe bus 112. Each of the NPUs includes elements such as, but not limited to, a processing core and memory (not shown). Each server in the system 100 includes a host central processing unit (CPU), and is connected to a network 130 via a respective network interface controller or card (NIC) as shown in the figure.

The system 100 incorporates unified memory addressing space using, for example, the partitioned global address space (PGAS) programming model. Thus, in the example of FIG. 1, each NPU on the server 101 can read data from, or write data to, memory on any other NPU on the server 101 or 102, and vice versa. For example, to write data from NPU_0 to NPU_n on the server 101, the data is sent from NPU_0 over the PCIe bus 111 to NPU_n; and to write data from NPU_0 on the server 101 to memory on NPU_m on the server 102, the data is sent from NPU_0 over the PCIe bus 111 to the NIC 121, then over the network 130 to the NIC 122, then over the PCIe bus 112 to NPU_m.

The system 100 can be used for applications such as but not limited to graph analytics and graph neural networks, and more specifically for applications such as but not limited to online shopping engines, social networking, recommendation engines, mapping engines, failure analysis, network management, and search engines. Such applications execute a tremendous number of memory access requests (e.g., read and write requests), and as a consequence also transfer (e.g., read and write) a tremendous amount of data for processing. While PCIe bandwidth and data transfer rates are considerable, they are nevertheless limiting for such applications. PCIe is simply too slow and its bandwidth is too narrow for such applications.

### SUMMARY

Embodiments according to the present disclosure provide a solution to the problem described above. Embodiments according to the present disclosure provide an improvement in the functioning of computing systems in general and applications such as, but not limited to, neural network and artificial intelligence (AI) workloads. More specifically, embodiments according to the present disclosure introduce methods, systems, and programming models that increase the speed at which applications such as neural network and AI workloads can be performed, by increasing the speeds at which memory access requests (e.g., read requests and write requests) between elements of the system are sent and received and resultant data transfers are completed. The disclosed systems, methods, and programming models allow processing units in the system to communicate without using a traditional network (e.g., Ethernet) that uses a relatively narrow and slow Peripheral Component Interconnect Express (PCIe) bus.

In embodiments, a system includes a high-bandwidth inter-chip network (ICN) that allows communication between neural network processing units (NPUs) in the system. For example, the ICN allows an NPU to communicate with other NPUs on the same compute node or server and also with NPUs on other compute nodes or servers. In embodiments, communication can be at the command level (e.g., at the direct memory access level) and at the instruction level (e.g., at the finer-grained load/store instruction level). The ICN allows NPUs in the system to communicate without using a PCIe bus, thereby avoiding its bandwidth limitations and relative lack of speed.

Data can be transferred between NPUs in a push mode or in a pull mode. When operating in a command-level push mode, a first NPU copies data from memory on the first NPU to memory on a second NPU and then sets a flag on the second NPU, and the second NPU waits until the flag is set to use the data pushed from the first NPU. When operating in a command-level pull mode, a first NPU allocates memory on the first NPU and then sets a flag on the second NPU to indicate the memory on the first NPU is allocated, and the second NPU waits until the flag is set to read the data from the allocated memory on the first NPU. When operating in an instruction-level push mode, an operand associated with a processing task that is being executed by a first processing unit is stored in a buffer on the first processing unit, and a result of the processing task is written to a buffer on a second processing unit.

These and other objects and advantages of the various embodiments of the invention will be recognized by those of ordinary skill in the art after reading the following detailed description of the embodiments that are illustrated in the various drawing figures.

### BRIEF DESCRIPTION OF DRAWINGS

The accompanying drawings, which are incorporated in and form a part of this specification and in which like numerals depict like elements, illustrate embodiments of the present disclosure and, together with the detailed description, serve to explain the principles of the disclosure.

FIG. 1 illustrates an example of a conventional system.

FIG. 2A is a block diagram illustrating an example of a system in embodiments according to the present disclosure.

FIG. 2B is a block diagram illustrating an example of an ICN topology in an embodiment according to the present disclosure.

FIG. 2C is a block diagram illustrating an example of a neural network processing unit (NPU) in embodiments according to the present disclosure.

FIG. 3A is a block diagram of an NPU in embodiments according to the present disclosure.

FIG. 3B illustrates an element of a switch in an NPU in embodiments according to the present disclosure.

FIG. 4 illustrates elements of NPUs for operation in a data push mode at the command level in embodiments according to the present disclosure.

FIG. 5 illustrates elements of NPUs for operation in a data pull mode at the command level in embodiments according to the present disclosure.

FIG. 6 illustrates elements of NPUs for operation in a push mode at the instruction level in embodiments according to the present disclosure.

FIG. 7 is a flowchart of an example of a method for inter-chip communication in embodiments according to the present disclosure.

FIG. 8 is a flowchart of an example of a method for a command-level push operation in embodiments according to the present disclosure.

FIG. 9 is a flowchart of an example of a method for a command-level pull operation in embodiments according to the present disclosure.

FIG. 10 is a flowchart of an example of a method for an instruction-level push operation in embodiments according to the present disclosure.

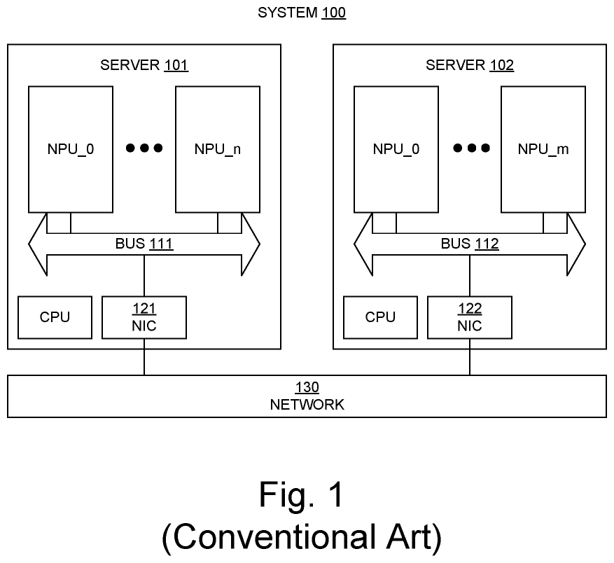

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computing system. It has proven convenient at times, principally for reasons of common usage, to refer to these signals as transactions, bits, values, elements, symbols, characters, samples, pixels, or the like.

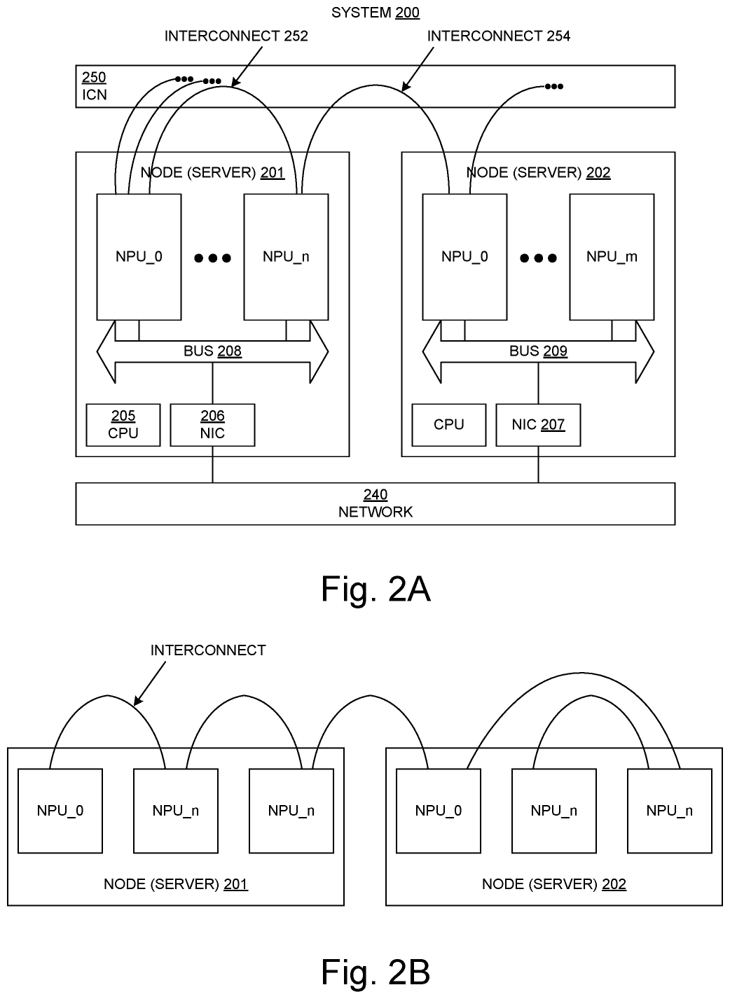

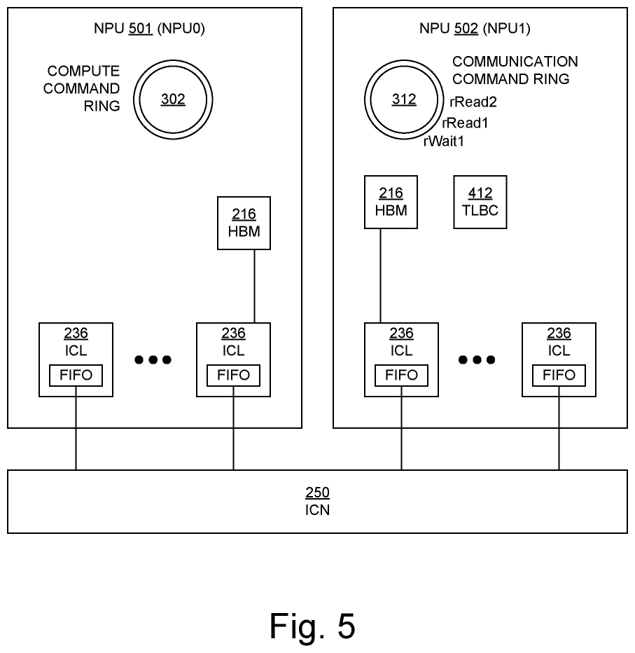

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “accessing,” “allocating,” “storing,” “receiving,” “sending,” “writing,” “reading,” “transmitting,” “loading,” “pushing,” “pulling,” “processing,” “caching,” “routing,” “determining,” “selecting,” “requesting,” “synchronizing,” “copying,” “mapping,” “updating,” “translating,” “generating,” “allocating,” or the like, refer to actions and processes of an apparatus or computing system (e.g., the methods of FIGS. 7, 8, 9, and 10) or similar electronic computing device, system, or network (e.g., the system of FIG. 2A and its components and elements). A computing system or similar electronic computing device manipulates and transforms data represented as physical (electronic) quantities within memories, registers or other such information storage, transmission or display devices.

Some elements or embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer storage media and communication media. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, double data rate (DDR) memory, random access memory (RAM), static RAMs (SRAMs), or dynamic RAMs (DRAMs), read only memory (ROM), electrically erasable programmable ROM (EEPROM), flash memory (e.g., an SSD) or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared and other wireless media. Combinations of any of the above can also be included within the scope of computer-readable media.

FIG. 2A is a block diagram illustrating an example of a system 200 in embodiments according to the present disclosure. The system 200 can be used for neural network and artificial intelligence (AI) workloads, but is not so limited. In general, the system 200 can be used for any parallel computing, including massive data parallel processing.

FIG. 2C is a block diagram illustrating an example of a neural processing unit NPU_0 in embodiments according to the present disclosure. The system 200 and NPU_0 are examples of a system and a processing unit for implementing methods such as those disclosed herein (e.g., the methods of FIG. 7-10).

The system 200 and NPU_0 can include elements or components in addition to those illustrated and described below, and elements or components can be arranged as shown in the figure or in a different way. Some of the blocks in the example system 200 and NPU_0 may be described in terms of the function they perform. Where elements and components of the system are described and illustrated as separate blocks, the present disclosure is not so limited; that is, for example, a combination of blocks/functions can be integrated into a single block that performs multiple functions. The system 200 can be scaled up to include additional NPUs, and is compatible with different scaling schemes including hierarchical scaling schemes and flattened scaling schemes.

In general, the system 200 includes a number of compute nodes or servers, and each compute node or server includes a number of parallel computing units or chips (e.g., NPUs). In the example of FIG. 2A, the system 200 includes compute node (servers) 201 and 202, hereinafter referred to simply as servers. While only two servers are illustrated and described, embodiments according to the present disclosure are not so limited.

In the embodiments of FIG. 2A, the server 201 includes a host central processing unit (CPU) 205, and is connected to a network 240 via a network interface controller or card (NIC) 206. The server 201 can include elements and components in addition to those about to be described.

In the embodiments of FIG. 2A, the parallel computing units of the server 201 include network processing units (NPUs) NPU_0, NPU_n that are connected to a Peripheral Component Interconnect Express (PCIe) bus 208, which in turn is connected to the NIC 206. The NPUs may also be implemented using, or may be referred to as, neural NPUs. The NPUs may also be implemented as, or using, general purpose graphic processing units or parallel processing units or any other processing units that can accelerate neural network data processing.

The server 202 includes elements like those of the server 201. That is, in embodiments, the servers 201 and 202 have identical structures (although cm′ may or may not be equal to ‘n’), at least to the extent described herein. Other servers in the system 200 may be similarly structured.

The NPUs on the server 201 can communicate with (are communicatively coupled to) each other over the bus 208. The NPUs on the server 201 can communicate with the NPUs on the server 202 over the network 240 via the buses 208 and 209 and the NICs 206 and 207.

In general, each of the NPUs on the server 201 includes elements such as, but not limited to, a processing core and memory. Specifically, in the embodiments of FIG. 2C, NPU_0 includes a network-on-a-chip (NoC) 210 coupled to one or more computing elements or processing cores (e.g., the core 212) and one or more caches (e.g., the cache 214). NPU_0 also includes one or more high bandwidth memories (HBMs), such as the HBM 216, coupled to the NoC 210. The processing cores, caches, and HBMs may also be collectively referred to herein as the cores 212, the caches 214, and the HBMs 216, respectively. In the example of FIG. 2C, the caches 214 are the last level of caches between the HBMs 216 and the NoC 210; the server 201 may include other levels of caches (e.g., L1, L2, etc.; not shown). Memory space in the HBMs 216 may be declared or allocated (e.g., at runtime) as buffers (e.g., ping-pong buffers, not shown in FIG. 2C).

NPU_0 may also include other functional blocks or components (not shown) such as a command processor, a direct memory access (DMA) block, and a PCIe block that facilitates communication to the PCIe bus 208. The NPU_O can include elements and components other than those described herein or shown in FIG. 2C.

Other NPUs on the servers 201 and 202 include elements and components like those of the NPU_0. That is, in embodiments, the NPUs on the servers 201 and 202 have identical structures, at least to the extent described herein.

The system 200 of FIG. 2A includes a high-bandwidth inter-chip network (ICN) 250, which allows communication between the NPUs in the system 200. That is, the NPUs in the system 200 are communicatively coupled to each other via the ICN 250. For example, the ICN 250 allows NPU_0 to communicate with other NPUs on the server 201 and also with NPUs on other servers (e.g., the server 202). In the example of FIG. 2A, the ICN 250 includes interconnects (e.g., the interconnects 252 and 254) that directly connect two NPUs and permit two-way communication between the two connected NPUs. The interconnects may be half-duplex links on which only one NPU can transmit data at a time, or they may be full-duplex links on which data can be transmitted in both directions simultaneously. In an embodiment, the interconnects (e.g., the interconnects 252 and 254) are lines or cables based on or utilizing Serial/Deserializer (SerDes) functionality.

In the example of FIG. 2A, the interconnect 252 is a hard-wired or cable connection that directly connects NPU_0 to NPU_n on the server 201, and the interconnect 254 is a hard-wired or cable connection that directly connects NPU_n on the server 201 to NPU_0 on the server 202. That is, for example, one end of the interconnect 252 is connected to NPU_0 on the server 201 and the other end is connected to NPU_n. More specifically, one end of the interconnect 252 is plugged into a port on or coupled to the switch 234 (FIG. 2C) and the other end of the interconnect 252 is plugged into a port on or coupled to a switch of the NPU_n.

The actual connection topology (which NPU is connected to which other NPU) is a design or implementation choice. FIG. 2B is a block diagram illustrating an example of an ICN topology in an embodiment according to the present disclosure. Only three NPUs per server are shown; however, the present disclosure is not so limited. In the example, NPU_0 on the server 201 is connected to NPU_1 on the server 201, which in turn is connected to NPU_2 on the server 201. NPU_0 on the server 201 may be connected to an NPU on another server (not shown). NPU_2 on the server 201 is connected to NPU_0 on the server 202. While an NPU may be connected to its immediate neighbor on a server or its immediate neighbor on an adjacent server, the present disclosure is not so limited. Thus, in the example of FIG. 2B, NPU_0 on the server 202 is connected to NPU_2 on the server 202, which in turn is connected to NPU_1 on the server 202. NPU_1 on the server 202 may be connected to an NPU on yet another server (not shown). Interconnects that connect NPUs on the same server may be referred to as intra-chip interconnects, and interconnects that connect NPUs on different servers may be referred to as inter-chip interconnects.

Communication between NPUs can be at the command level (e.g., a DMA copy) and at the instruction level (e.g., a direct load or store). The ICN 250 allows servers and NPUs in the system 200 to communicate without using the PCIe bus 208, thereby avoiding its bandwidth limitations and relative lack of speed.

Communication between NPUs includes the transmission of memory access requests (e.g., read requests and write requests) and the transfer of data in response to such requests. Communication between any two NPUs—where the two NPUs may be on the same server or on different servers—can be direct or indirect.

Direct communication is over a single link between the two NPUs, and indirect communication occurs when information from one NPU is relayed to another NPU via one or more intervening NPUs. For example, in the configuration exemplified in FIG. 2A, NPU_0 on the server 201 can communicate directly with NPU_n on the server 201 via the interconnect 252, and can communicate indirectly with NPU_0 on the server 202 via the interconnect 252 to NPU_n and the interconnect 254 from NPU_n to NPU_0 on the server 202.

In embodiments, the system 200 incorporates unified memory addressing space using, for example, the partitioned global address space (PGAS) programming model. Accordingly, memory space in the system 200 can be globally allocated so that the HBMs 216 on the NPU_0, for example, are accessible by the NPUs on that server and by the NPUs on other servers in the system 200, and the NPUs on the NPU_0 can access the HBMs on other NPUs/servers in the system. Thus, in the example of FIG. 2A, one NPU can read data from, or write data to, another NPU in the system 200, where the two NPUs may be on the same server or on different servers, and where the read or write can occur either directly or indirectly as described above.

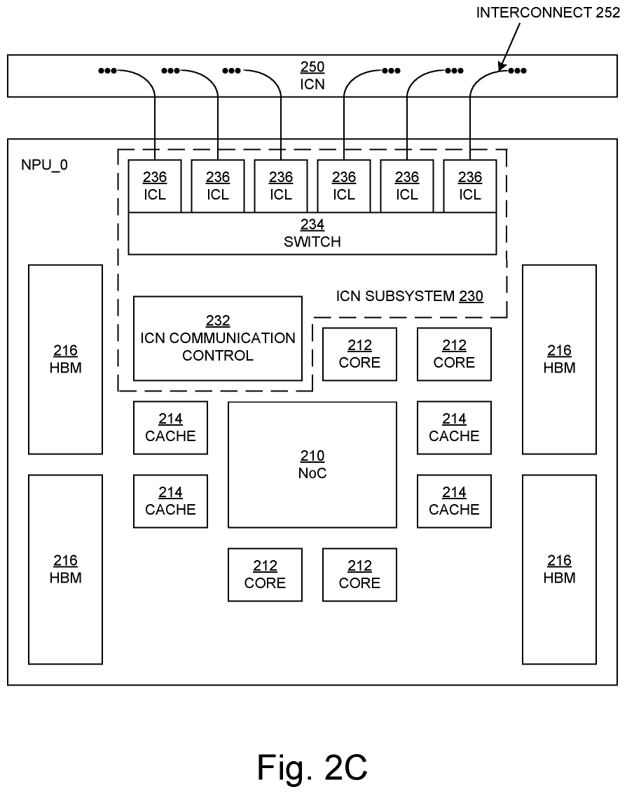

The server 201 is coupled to the ICN 250 by the ICN subsystem 230 (FIG. 2C), which is coupled to the NoC 210. In the FIG. 2C embodiments, the ICN subsystem 230 includes an ICN communication control block (communication controller) 232, the switch 234, and one or more inter-communication links (ICLs) (e.g., the ICL 236; collectively, the ICLs 236). The ICLs 236 can be coupled to or a component of the switch 234. In embodiments, each of the ICLs 236 constitutes or includes a port. In an embodiment, there are seven ICLs. Each of the ICLs 236 is connected to a respective interconnect (e.g., the interconnect 252). For example, in embodiments, one end of the interconnect 252 is plugged into the ICL (port) 236 on the NPU_0 (and the other end of the interconnect is plugged into another ICL/port on another NPU). The ICN subsystem 230 is described further below in conjunction with FIG. 3A.

In the configuration of FIG. 2C, a memory access request (e.g., a read request or a write request) by NPU_0, for example, is issued from the NoC 210 to the ICN communication control block 232. The memory access request includes an address that identifies which server/NPU/HBM is the destination of the memory access request. The ICN communication control block 232 uses the address to determine which of the ICLs 236 is connected (directly or indirectly) to the server/NPU/HBM identified by the address. The memory access request is then routed to the selected ICL 236 by the switch 234, then through the ICN 250 to the server/NPU/HBM identified by the address. At the receiving end, the memory access request is received at an ICL of the destination NPU, provided to the ICN communication control block and then the NoC of that NPU, and finally to the HBM on that NPU addressed by the memory access request. If the memory access request is a write request, then data associated with the request is written to (loaded or stored) at the address in the HBM on the destination NPU. If the memory access request is a read request, then data at the address in the HBM on the destination NPU is returned to NPU_0. In this manner, inter-chip communication is expeditiously accomplished using the high-bandwidth ICN 250, bypassing the PCIe bus 208 and thereby avoiding its bandwidth limitations and relative lack of speed.

FIG. 3A is a block diagram of an NPU 300 that includes the ICN subsystem 230 in embodiments according to the present disclosure. The NPU 300 is an example of the NPUs NPU_0, . . . , NPU_n discussed above in conjunction with FIGS. 2A and 2C. The NPU 300 can include elements and components other than those described or shown in FIG. 3A.

The NPU 300 of FIG. 3A includes one or more compute command rings (e.g., the compute command ring 302; collectively, the compute command rings 302) coupled between the cores 212 and the ICN subsystem 230. The compute command rings 302 may be implemented as a number of buffers. There may be a one-to-one correspondence between the cores 212 and the compute command rings 302. Commands from processes executing on a core 212 are pushed into the header of a respective compute command ring 302 in the order in which they are issued or are to be executed.

The ICN subsystem 230 includes ICN communication command rings (e.g., the communication command ring 312; collectively, the communication command rings 312) coupled to the compute command rings 302. The communication command rings 312 may be implemented as a number of buffers. There may be a one-to-one correspondence between the communication command rings 312 and the compute command rings 302. In an embodiment, there are 16 compute command rings 302 and 16 communication command rings 312.

In the embodiments of FIG. 3A, the ICN communication control block 232 includes a command dispatch block 304 and an instruction dispatch block 306. The command dispatch block 304 and the instruction dispatch block 306 are used for a memory access request by the NPU 300 that addresses another NPU. The command dispatch block 304 is used for a memory access request that involves relatively large amounts of data (e.g., two or more megabytes). The instruction dispatch block 306 provides a finer level of control, and is used for a memory access request that involves a smaller amount of data (e.g., less than two megabytes; e.g., 128 or 512 bytes). Generally speaking, in embodiments, the command dispatch block 304 handles ICN reads and writes, and the instruction dispatch block 306 handles remote stores and remote loads, although the present invention is not so limited. Commands from the communication command rings 312 are sent to the command dispatch block 304. Instructions from the NoC 210 are sent to the instruction dispatch block 306. The instruction dispatch block 306 may include a remote load/store unit (not shown).

More specifically, when a compute command is decomposed and dispatched to one (or more) of the cores 212, a kernel (e.g., a program, or a sequence of processor instructions) will start running in that core or cores. When there is a memory access instruction, the instruction is issued to memory: if the memory address is determined to be a local memory address, then the instruction goes to a local HBM 216 via the NoC 210; otherwise, if the memory address is determined to be a remote memory address, then the instruction goes to the instruction dispatch block 306.

The ICN subsystem 230 also includes a number of chip-to-chip (C2C) DMA units (e.g., the DMA unit 308; collectively, the DMA units 308) that are coupled to the command and instruction dispatch blocks 304 and 306. The DMA units 308 are also coupled to the NoC 210 via C2C fabric 309 and a network interface unit (NIU) 310, and are also coupled to the switch 234, which in turn is coupled to the ICLs 236 that are coupled to the ICN 250.

In an embodiment, there are 16 communication command rings 312 and seven DMA units 308. There may be a one-to-one correspondence between the DMA units 308 and the ICLs 236. The command dispatch block 304 maps the communication command rings 312 to the DMA units 308 and hence to the ICLs 236. The command dispatch block 304, the instruction dispatch block 306, and the DMA units 308 may each include a buffer such as a first-in first-out (FIFO) buffer (not shown).

The ICN communication control block 232 maps an outgoing memory access request to an ICL 236 that is selected based on the address in the request. The ICN communication control block 232 forwards the memory access request to the DMA unit 308 that corresponds to the selected ICL 236. From the DMA unit 308, the request is then routed by the switch 234 to the selected ICL.

An incoming memory access request is received by the NPU 300 at an ICL 236, forwarded to the DMA unit 308 corresponding to that ICL, and then forwarded through the C2C fabric 309 to the NoC 210 via the NIU 310. For a write request, the data is written to a location in an HBM 216 corresponding to the address in the memory access request. For a read request, the data is read from a location in an HBM 216 corresponding to the address in the memory access request.

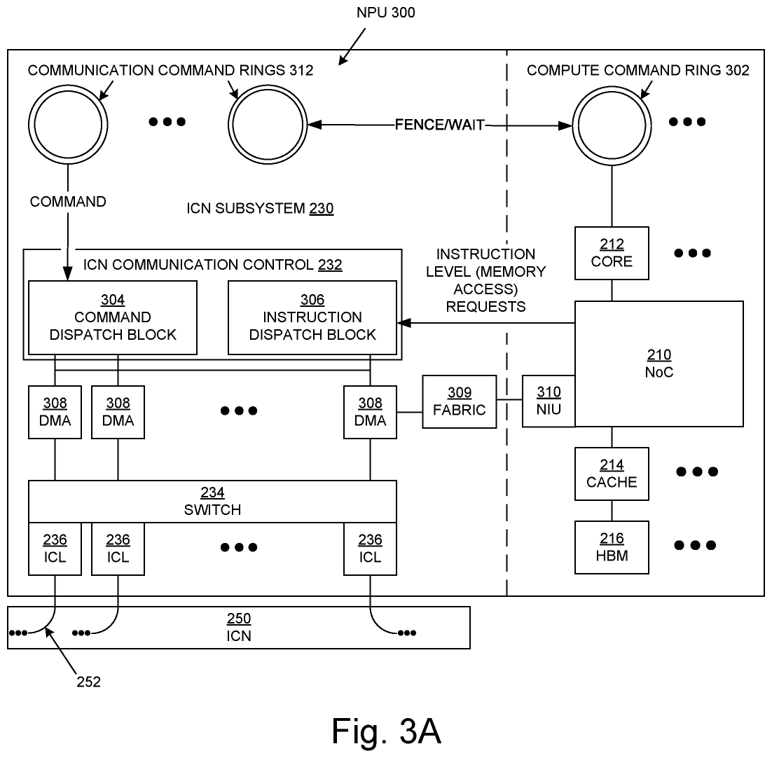

In embodiments, synchronization of the compute command rings 302 and communication command rings 312 is achieved using FENCE and WAIT commands. For example, a processing core 212 of the NPU 300 may issue a read request for data for a processing task, where the read request addresses an NPU other than the NPU 300. A WAIT command in the compute command ring 302 prevents the core 212 from completing the task until the requested data is received. The read request is pushed into a compute command ring 302, then to a communication command ring 312. An ICL 236 is selected based on the address in the read request, and the command dispatch block 304 or the instruction dispatch block 306 maps the read request to the DMA unit 308 corresponding to the selected ICL 236. Then, when the requested data is fetched from the other NPU and loaded into memory (e.g., an HBM 216) of the NPU 300, the communication command ring 312 issues a sync command (FENCE), which notifies the core 212 that the requested data is available for processing. More specifically, the FENCE command sets a flag in the WAIT command in the compute command ring 302, allowing the core 212 to continue processing the task. Additional discussion is provided below in conjunction with FIGS. 4, 5, and 6.

Continuing with the discussion of FIG. 3A, when a relatively large amount of data is to be read, the read request may be divided into a number of smaller requests, to preserve bandwidth for example. In that case, when the individual pieces of requested data are all received by the NPU 300, they are accumulated by the DMA unit 308 and then loaded into memory (e.g., an HBM 216) of the NPU 300, and then the communication command ring 312 uses a sync command (FENCE) to notify the core 212 that the requested data is available for processing as just described above.

FIG. 3B illustrates elements 320 (e.g., ports) of the switch 234 in embodiments according to the present disclosure. A memory access request or data transfer from a DMA block 308 is forwarded to an ICL 216 and the ICN 250 via the egress path 322. A memory access request or data transfer from another NPU that addresses the NPU_0 is forwarded to a DMA block 308 via the ingress path 324. A memory access request or data transfer from another NPU that addresses an NPU other than the NPU_0, and is to be relayed by the NPU_0, is forwarded to the egress path 322 from the ingress path 324.

FIG. 4 illustrates elements of NPUs for operation in a data push mode at the command level in embodiments according to the present disclosure. Only selected elements of two NPUs 401 and 402 are shown. The NPUs 401 and 402 are embodiments of the NPUs of the system 200 (FIGS. 2A and 2C) and may include elements of the NPU 300 of FIG. 3 as well as additional elements. The NPUs 401 and 402 may be on the same server or on different servers of the system 200.

Table 1 provides an example of programming at the command level in the push mode, where the NPU 401, referred to as NPU0 and the producer, is pushing data to the NPU 402, referred to as NPU1 and the consumer.

TABLE 1
Example of Command-Level Programming (Push Mode)

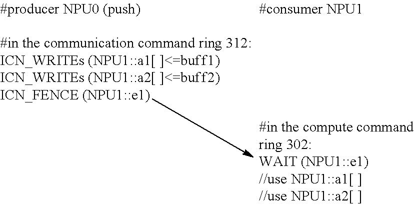

In the example of Table 1, NPU0 has completed a processing task, and is to push the resultant data to NPU1. Accordingly, NPU0 copies (writes) data from a local buffer (buff1) to address a1 (an array of memory at a1) on NPU1, and also copies (writes) data from another local buffer (buff2) to address a2 (an array of memory at a2) on NPU1. Once both write requests in the communication command ring 312 are completed, NPU0 uses the ICN_FENCE command to set a flag (e1) on NPU1. On NPU1, the WAIT command in the compute command ring 302 is used to instruct NPU1 to wait until the flag is set. When the flag is set in the WAIT command, then NPU1 knows that both write operations are completed and the data can be used.

The example of Table 1 is illustrated in FIG. 4. The communication command ring 312 of the NPU 401 forwards, in order, the first write request (rWrite1) and the second write request (rWrite2) to a FIFO in the command dispatch block 304. In an embodiment, the command dispatch block 304 includes or is coupled to a translation lookaside buffer controller (TLBC) 412. If the write requests include virtual addresses, then the TLBC translates the virtual addresses to physical addresses.

The command dispatch block 304 also includes a routing table that identifies which ICL 236 is to be used to route the write requests from the NPU 401 to the NPU 402 based on the addresses in the write requests, as previously described herein. Once the write requests are completed (once the data is written to the HBM 216 on the NPU 402), the flag in the WAIT command is set using the FENCE command (rFENCE), as described above. The compute command ring 302 on the NPU 402 includes, in order, the WAIT command (Wait) and the first and second use commands (use1 and use2). When the flag is set in the WAIT command, the use commands in the compute command ring 302 can be executed, and are used to instruct the appropriate processing core on the NPU 402 that the data in the HBM 216 is updated and available.

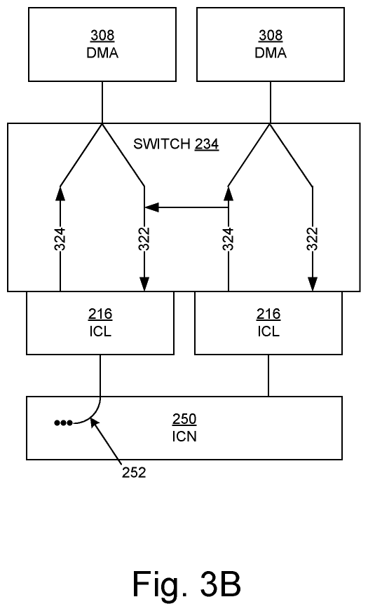

FIG. 5 illustrates operation in a data pull mode at the command level in embodiments according to the present disclosure. Only selected elements of two NPUs 501 and 502 are shown. The NPUs 501 and 502 are embodiments of the NPUs of the system 200 (FIGS. 2A and 2C) and may include elements of the NPU 300 of FIG. 3 as well as additional elements. The NPUs 501 and 502 may be on the same server or on different servers of the system 200.

Table 2 provides an example of programming at the command level in the pull mode, where the NPU 502, referred to as NPU1 and the consumer, is pulling data from the NPU 501, referred to as NPU0 and the producer.

TABLE 2
Example of Command-Level Programming (Pull Mode)

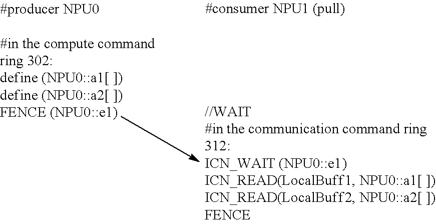

In the example of Table 2, NPU0 allocates local buffers a1 and a2 in the HBM 216. Once both buffers are allocated, NPU0 uses the FENCE command in the compute command ring 302 to set a flag (e1) on NPU1. On NPU1, the WAIT command in the communication command ring 312 is used to instruct NPU1 to wait until the flag is set. When the flag is set in the WAIT command, then NPU1 is instructed that both buffers are allocated and the read requests can be performed.

The example of Table 2 is illustrated in FIG. 5. The communication command ring 312 of the NPU 502 includes, in order, the WAIT command (rWait) and the first and second read requests (rRead1 and rRead2). Once the buffers are allocated as described above, the flag in the WAIT command in the communication command ring 312 is set using the FENCE command, as described above. When the flag is set in the WAIT command, the first and second read requests in the communication command ring 312 can be executed, and the data in the allocated buffers in the HBM 216 can be read.

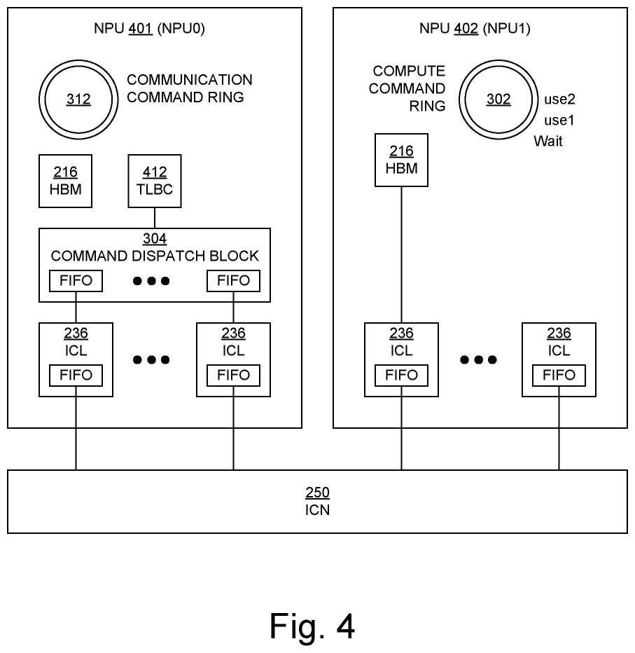

FIG. 6 illustrates operation at the instruction level in embodiments according to the present disclosure. Only selected elements of two NPUs 601 and 602 are shown. The NPUs 601 and 602 are embodiments of the NPUs of the system 200 (FIGS. 2A and 2C) and may include elements of the NPU 300 of FIG. 3 as well as additional elements. The NPUs 601 and 602 may be on the same server or on different servers of the system 200.

In the following discussion, the term “warp” is used to refer to the basic unit of execution: the smallest unit or segment of a program that can run independently, although there can be data-level parallelism. While that term may be associated with a particular type of processing unit, embodiments according to the present disclosure are not so limited.

Each warp includes a collection of a number of threads (e.g., 32 threads). Each of the threads executes the same segment of an instruction, but has its own input and output data.

With reference to FIG. 6, the HBM 216 on the NPU 601 includes memory space declared or allocated (e.g., at runtime) as a ping-pong buffer 610, which includes a ping buffer 610a and a pong buffer 610b. Similarly, the HBM 216 on the NPU 606 includes memory space declared or allocated (e.g., at runtime) as a ping-pong buffer 612, which includes a ping buffer 612a and a pong buffer 612b.

Operands associated with a processing task (e.g., a warp) that is being executed by the NPU 601 are stored in the ping-pong buffer 610. For example, an operand is read from the pong buffer 610b, that operand is used by the task to produce a result, and the result is written to (using a remote load instruction) to the ping buffer 612a on the NPU 602. Next, an operand is read from the ping buffer 610a, that operand is used by the task to produce another result, and that result is written to (using a remote load instruction) to the pong buffer 612b on the NPU 602. The writes (remote loads) are performed using the instruction dispatch block 306 and the C2C DMA units 308.

Tables 3 and 4 provide an example of programming at the instruction level in the push mode, where the NPU 601, referred to as NPU0 and the producer, is pushing data to the NPU 602, referred to as NPU1 and the consumer.

In the example of FIG. 6 and Table 3, multiple warps are running simultaneously on the NPU 601. The warps can be working cooperatively to update and load data into an array “Data” on the NPU 601 of FIG. 6 (see Tables 3 and 4 below); each of the warps is responsible for some portion of that data. Accordingly, it may be necessary to synchronize the results from those warps, so that the NPU 602 can be notified not just when all warps have finished executing but also when all of the resultant data has been loaded into the array.

To accomplish that, one of the threads (e.g., the first thread in the first warp, warp-0; see Table 3) running on the NPU 601 is selected as a representative of the thread block that includes the warps. The selected thread communicates with a thread on the NPU 602. Specifically, once all of the data is loaded and ready on the NPU 601, the selected thread uses a subroutine (referred to in Table 3 as the threadfence_system subroutine) to determine that, and then to set a flag (marker) on the NPU 602 to indicate to the NPU 602 that all of the writes (remote loads) have been completed.

TABLE 3
Example of Instruction-Level Programming
(Push Mode) on NPU 601

| | |
|---|---|
| //producer on NPU0, warp-0 | //to NPU1 |
| Data[ . . . ]= . . . ; | |
| _ syncthread( ); | //PC + mem-order |
| If(syncThread) { | //mem-order |
| If(wid==0) { | |
| _ threadfence_system( ); | |
| marker = 1; | //to NPU1 |
| } | //PC + mem-order |
| _syncwarp( ); | |
| } | //to NPU1 |
| Data2[ ]= . . . ; | |

TABLE 4
Example of Instruction-Level Programming
(Push Mode) on NPU 602

```
//consumer on NPU1, warp-0
If(syncThread && wid==0) {
  while(marker !=1)
    sleep(N);
}
_ syncthread( );  //PC + mem-order
. . . = data[ ];
```

The examples of Tables 3 and 4 include only a single warp (warp-0); however, as noted, there can be multiple warps operating in parallel, with each warp executing the same instructions shown in these tables but with different inputs and outputs. Also, while Tables 3 and 4 are examples of a push mode, the present disclosure is not so limited, and instruction-level programming can be performed for a pull mode.

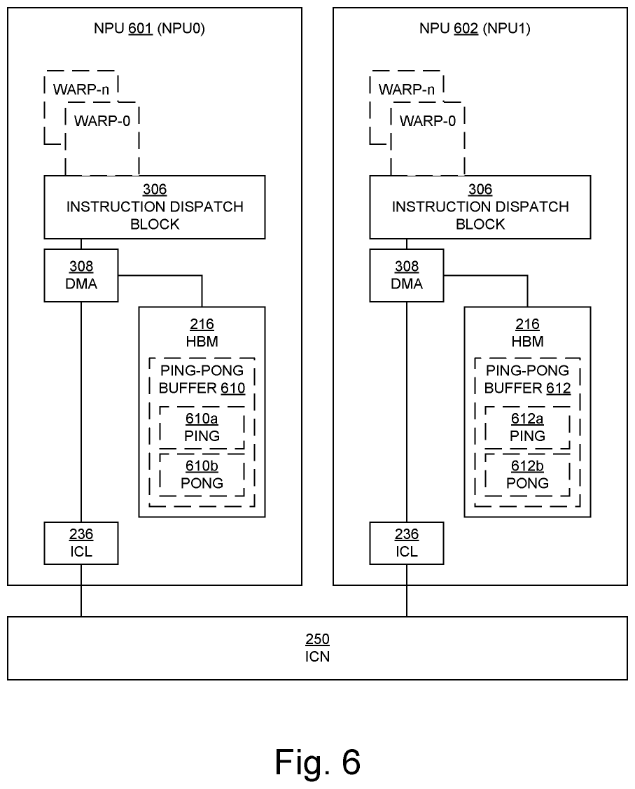

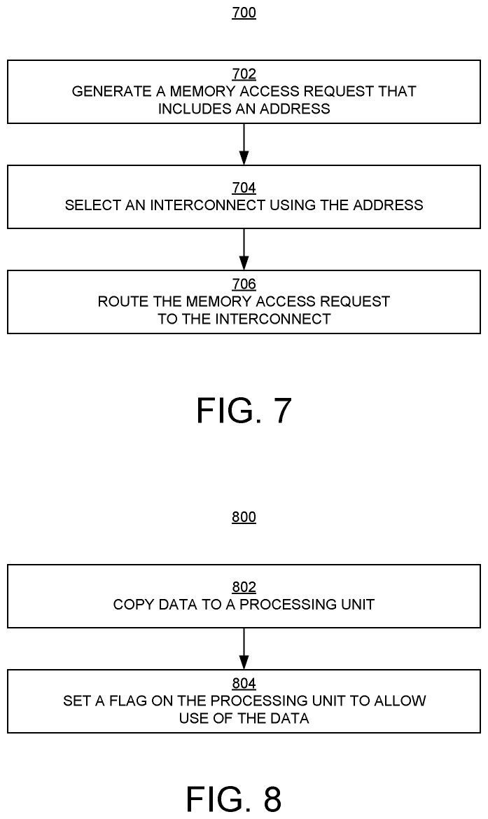

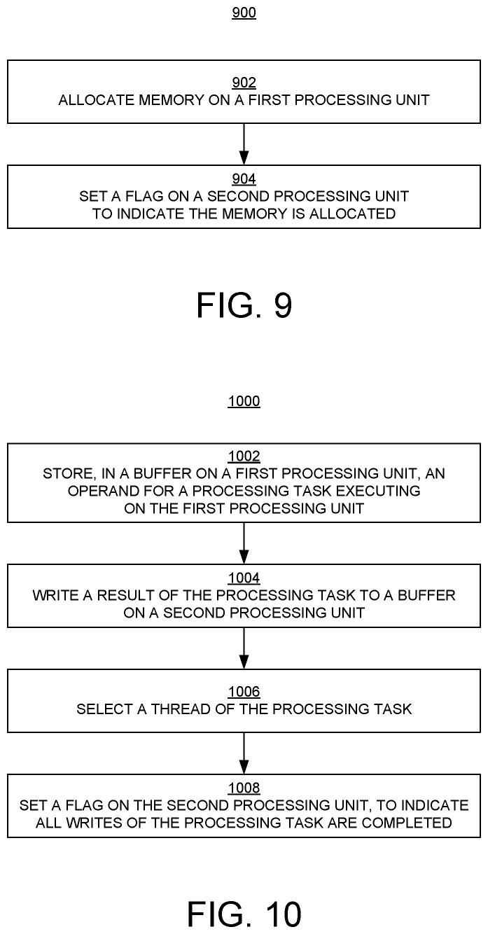

FIG. 7 is a flowchart 700 of an example of a method for inter-chip communication in embodiments according to the present disclosure. FIG. 8 is a flowchart 800 of an example of a command-level push operation in embodiments according to the present disclosure. FIG. 9 is a flowchart 900 of an example of a command-level pull operation in embodiments according to the present disclosure. FIG. 10 is a flowchart 1000 of an example of an instruction-level push operation in embodiments according to the present disclosure.

All or some of the operations represented by the blocks in the flowcharts of FIGS. 7-10 can be implemented as computer-executable instructions residing on some form of non-transitory computer-readable storage medium, and executed by, for example, the system 200 of FIG. 2A and its elements and components.

In block 702 of FIG. 7, a first processing unit on a first server or node or compute node in the system 200 generates a memory access request that includes an address that identifies a second processing unit in the system that is the destination of the memory access request. The first processing unit includes interconnects configured to communicatively couple the first processing unit to other processing units including the second processing unit.

In block 704 of FIG. 7, the first processing unit uses the address to select an interconnect that connects the first processing unit and the second processing unit.

In block 706, the first processing unit routes the memory access request to the selected interconnect and consequently to the second processing unit. When the memory access request is a read request, the first processing unit receives data from the second processing unit over the interconnect.

In block 802 of FIG. 8, the first processing unit copies data from memory on the first processing unit to memory on the second processing unit.

In block 804, the first processing unit sets a flag on the second processing unit. The flag, when set, allows the second processing unit to use the data pushed from the first processing unit.

In block 902 of FIG. 9, the first processing unit allocates memory on the first processing unit.

In block 904, the first processing unit sets a flag on the second processing unit to indicate the memory on the first processing unit is allocated. The flag, when set, allows the second processing unit to read the data from the memory on the first processing unit.

In block 1002 of FIG. 10, the first processing unit stores, in a buffer on the first processing unit, an operand associated with a processing task that is being executed by the first processing unit.

In block 1004, the first processing unit writes, to a buffer on the second processing unit, a result of the processing task.

In block 1006, the first processing unit selects a thread of the processing task.

In block 1008, the first processing unit sets a flag on the second processing unit using the thread. The flag indicates to the second processing unit that all writes associated with the processing task are completed.

In summary, embodiments according to the present disclosure provide an improvement in the functioning of computing systems in general and applications such as, for example, neural networks and AI workloads that execute on such computing systems. More specifically, embodiments according to the present disclosure introduce methods, programming models. and systems that increase the speed at which applications such as neural network and AI workloads can be operated, by increasing the speeds at which memory access requests (e.g., read requests and write requests) between elements of the system are transmitted and resultant data transfers are completed.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of configurations. In addition, any disclosure of components contained within other components should be considered as examples because many other architectures can be implemented to achieve the same functionality.

Although the subject matter has been described in language specific to structural features and/or methodological acts, it is to be understood that the subject matter defined in this disclosure is not necessarily limited to the specific features or acts described above. Rather, the specific features and acts described above are disclosed as example forms of implementing this disclosure.

Embodiments according to the invention are thus described. While the present invention has been described in particular embodiments, the invention should not be construed as limited by such embodiments, but rather construed according to the following claims.

What is claimed is:

1. A processing unit on a first server, the processing unit comprising:
a plurality of processing cores;
a plurality of memories coupled to the processing cores;
a plurality of interconnects configured to communicatively couple the processing unit to a plurality of other processing units including a second processing unit, wherein the plurality of interconnects comprises an interconnect that is connected at one end to a port of the processing unit and is connected at another end to a port of the second processing unit; and
a communication controller coupled to the processing cores and that maps an outgoing memory access request to a selected interconnect of the plurality of interconnects based on an address in the memory access request.

2. The processing unit of claim 1, wherein the second processing unit is on the first server, and wherein the processing unit and the second processing unit are also communicatively coupled to each other via a bus on the first server.

3. The processing unit of claim 1, wherein the second processing unit is on a second server, wherein the processing unit and the second processing unit are also communicatively coupled to each other via: a first bus and a first network interface card on the first server, a second bus and a second network interface card on the second server, and a network coupled to the first network interface card and to the second network interface card.

4. The processing unit of claim 1, further comprising a switch coupled to the plurality of interconnects.

5. The processing unit of claim 1, wherein the communication controller comprises:
a first functional block for a first type of the memory access requests associated with a first amount of data; and
a second functional block for a second type of the memory access requests associated with a second amount of data that is smaller than the first amount.

6. The processing unit of claim 5, wherein the first type of the memory access requests is issued by a processing core of the plurality of processing cores to a buffer coupled to the first functional block, and wherein the second type of the memory requests is issued by a processing core of the plurality of processing cores to the second functional block via a network-on-a-chip.

7. The processing unit of claim 1, operable for pushing data to the second processing unit in a push mode, wherein in the push mode the processing unit copies data from memory on the processing unit to memory on the second processing unit and then sets a flag on the second processing unit to indicate that the data pushed from the first processing unit is available for use.

8. The processing unit of claim 1, operable in a pull mode wherein data from the processing unit is pulled from the processing unit by the second processing unit, wherein in the pull mode the processing unit allocates memory on the processing unit and then sets a flag on the second processing unit to indicate the memory on the processing unit is allocated and the data is available to read from the memory on the processing unit.

9. The processing unit of claim 1, operable for pushing data to the second processing unit in a push mode, wherein in the push mode: an operand associated with a processing task that is being executed by the first processing unit is stored in a buffer on the first processing unit, and a result of the processing task is written to a buffer on the second processing unit.

10. The processing unit of claim 9, wherein the processing task comprises a plurality of threads, wherein a thread of the plurality of threads is selected and communicates with a thread running on the second processing unit to set a flag on the second processing unit to indicate to the second processing unit that all writes to the buffer on the second processing unit and associated with the processing task are completed.

11. A system, comprising:
a plurality of nodes, wherein each node of the plurality of nodes comprises a plurality of processing units including a first processing unit and a second processing unit, and wherein each processing unit of the plurality of processing units comprises a plurality of ports; and
an inter-chip network coupled to the plurality of nodes, wherein the inter-chip network comprises a plurality of interconnects configured to communicatively couple the plurality of processing units, and wherein a port of the plurality of ports of the first processing unit is connected to a port of the plurality of ports of the second processing unit by an interconnect of the plurality of interconnects that is connected at one end to the port of the first processing unit and is connected at another end to the port of the second processing unit.

12. The system of claim 11, wherein the first processing unit and the second processing unit are on a same node of the plurality of nodes, and wherein the first processing unit and the second processing unit are also communicatively coupled to each other via a bus on said same node.

13. The system of claim 11, wherein the first processing unit is on a first node of the plurality of nodes, wherein the second processing unit is on a second node of the plurality of nodes, and wherein the first processing unit and the second processing unit are also communicatively coupled to each other via: a first bus and a first network interface card on the first node, a second bus and a second network interface card on the second node, and a network coupled to the first network interface card and to the second network interface card.

14. The system of claim 11, wherein the first processing unit pushes data to the second processing unit when operating in a push mode, wherein in the push mode the first processing unit copies data from memory on the first processing unit to memory on the second processing unit and then sets a flag on the second processing unit, and wherein the second processing unit waits until the flag is set to use the data pushed from the first processing unit.

15. The system of claim 11, wherein the second processing unit pulls data from the first processing unit when operating in a pull mode, wherein in the pull mode the first processing unit allocates memory on the first processing unit and then sets a flag on the second processing unit to indicate the memory on the first processing unit is allocated, and wherein the second processing unit waits until the flag is set to read the data from the memory on the first processing unit.

16. The system of claim 11, wherein the first processing unit pushes data to the second processing unit when operating in a push mode, wherein in the push mode: an operand associated with a processing task that is being executed by the first processing unit is stored in a buffer on the first processing unit, and a result of the processing task is written to a buffer on the second processing unit.

17. The system of claim 16, wherein the processing task comprises a plurality of threads, wherein a thread of the plurality of threads is selected and communicates with a thread running on the second processing unit to set a flag on the second processing unit to indicate to the second processing unit that all writes to the buffer on the second processing unit and associated with the processing task are completed.

18. A computer-implemented method for inter-chip communication, the method comprising:
generating, by a first processing unit on a first node, a memory access request comprising an address that identifies a second processing unit, wherein the first processing unit comprises a plurality of interconnects configured to communicatively couple the first processing unit to a plurality of other processing units including the second processing unit;
selecting, by the first processing unit and using the address, an interconnect of the plurality of interconnects that connects the first processing unit and the second processing unit, wherein the interconnect is connected at one end to a port of the first processing unit and is connected at another end to a port of the second processing unit;
routing, by the first processing unit, the memory access request to the interconnect.

19. The computer-implemented method of claim 18, further comprising receiving, at the first processing unit and over the interconnect, data from the second processing unit when the memory access request is a read request.

20. The computer-implemented method of claim 18, wherein the second processing unit is on the first node, and wherein the first processing unit and the second processing unit are also communicatively coupled to each other via a bus on the first node.

21. The computer-implemented method of claim 18, wherein the second processing unit is on a second node, wherein the first processing unit and the second processing unit are also communicatively coupled to each other via: a first bus and a first network interface card on the first node, a second bus and a second network interface card on the second node, and a network coupled to the first network interface card and to the second network interface card.

22. The computer-implemented method of claim 18, wherein the first processing unit pushes data to the second processing unit during operation in a push mode, wherein the method further comprises:
copying, by the first processing unit, data from memory on the first processing unit to memory on the second processing unit; and
setting, by the first processing unit, a flag on the second processing unit, wherein the flag when set allows the second processing unit to use the data pushed from the first processing unit.

23. The computer-implemented method of claim 18, wherein data is pulled from the first processing unit by the second processing unit during operation in a pull mode, wherein the method further comprises:
allocating, by the first processing unit, memory on the first processing unit; and
setting, by the first processing unit, a flag on the second processing unit to indicate the memory on the first processing unit is allocated, wherein the flag when set allows the second processing unit to read the data from the memory on the first processing unit.

24. The computer-implemented method of claim 18, wherein the first processing unit pushes data to the second processing unit during operation in a push mode, wherein the method further comprises:
storing, by the first processing unit in a buffer on the first processing unit, an operand associated with a processing task that is being executed by the first processing unit; and
writing, by the first processing unit to a buffer on the second processing unit, a result of the processing task.

25. The computer-implemented method of claim 24, wherein the processing task comprises a plurality of threads, and wherein the method further comprises:
selecting, by the first processing unit, a thread of the plurality of threads; and
setting, by the first processing unit using the thread, a flag on the second processing unit to indicate to the second processing unit that all writes to the buffer on the second processing unit and associated with the processing task are completed.
